(19) United States
(12) Patent Application Publication
(10) Pub. No.: US 2023/0384078 A1
(43) Pub. Date: Nov. 30, 2023

(54) SYSTEMS, DEVICES, AND METHODS FOR UNMANNED POWER LINE DIAMETER MEASUREMENT

(71) Applicant: BEIROBOTICS LLC, Richmond, VA (US)

(72) Inventors: Michael Kenneth BEIRO, Richmond, VA (US); Chase Hamilton COBLE, North Chesterfield, VA (US); David Carson SCHUL, Richmond, VA (US)

(21) Appl. No.: 18/201,563

(22) Filed: May 24, 2023

Related U.S. Application Data
(60) Provisional application No. 63/345,109, filed on May 24, 2022.

(51) Int. Cl. G01B 5/10; B64U 20/87

(52) U.S. Cl. CPC G01B 5/10; B64U 20/87; G01B 2210/44; B64U 2101/26

(57) ABSTRACT

An apparatus, system, or method for performing work on electrical power lines and/or splices on electrical power lines that may include an unmanned aerial vehicle (UAV), a power line measurement device, a support frame selectively releasably attached to the UAV, and a plurality of flexible dielectric attachment lines attaching the power line device to the support frame. The power line measurement device configured to determine measurement data by measuring a width of a live electrical power line and/or a splice on the electrical power line. Each of the attachment lines may be attached to a corresponding attachment point on the support frame and a corresponding attachment point on the power line measurement device.

### CROSS-REFERENCE TO RELATED APPLICATIONS

This application claims priority to U.S. Provisional Application Ser. No. 63/345,109, filed May 24, 2022, the contents of which are incorporated herein by reference in their entirety.

### TECHNICAL FIELD

This invention relates generally to electric power lines and more particularly to systems and methods for monitoring, inspecting, and/or repairing components of same.

### BACKGROUND

Currently unmanned aerial system (UAS) technologies have been deployed for use in the electric transmission and distribution (T&D) industry in several ways, including light detection and ranging (LI DAR), visual and infrared camera inspection, and in recent years have been utilized in contact with power lines for installations of products on grounded or distribution voltage hardware and contact measurements on transmission voltage lines. Installations have primarily been achieved of products that are specially designed for use by a UAS, not of products already in use by the T&D industry which are largely manipulated and installed by hot sticks (e.g., overhead faulted circuit indicators (FCIs) to assist utilities in reducing outage minutes). It is with respect to these and other considerations that aspects and embodiments of the present invention are presented herein.

One common inspection need is to measure the diameter of a power line to confirm or assesses the make and model of line for load capacity and utility asset recordkeeping verification. The inspection typically has two components: diameter measurement and visually counting the aluminum conductor strands on the outside of the conductor. These are combined to verify the make and model of the line, and its rated amperage. In the world of power line inspection, it is occasionally necessary to verify the diameter of a power line as one step of a testing process to confirm that the power line is able to properly handle the load being placed on it. It is challenging to measure the diameter of a power line, especially when the power line is live (e.g., carrying electricity). Such power lines may carry a high voltage, which is dangerous to approach, and may be high off the ground.

### SUMMARY

Described herein is one or more devices for measuring a diameter of live power lines (such devices are referred to herein as power line measurement devices) via a UAS carrying a Nonconductive Payload System (NPS). The power line measurement devices may generally include a class of monitoring devices that attach to a power line, so that one or more characteristics of the power line may be measured (e.g., a diameter). Different attachment systems may be utilized for attaching a power line measurement device, such as a modified caliper, to a UAS. The different attachment systems, and methods of using the same, are described herein.

In general, one innovative aspect of the subject described in this specification may be embodied in an apparatus or system that includes a deployment apparatus releasably attached to a power line measurement device at one or more points, wherein the power line measurement device is configured to determine measurement data by measuring a width of a live electrical power line and/or a splice on the electrical power line, a support frame configured to be selectively and releasably coupled to an unmanned aerial vehicle (UAV), and at least one attachment line connecting the deployment apparatus to the support frame.

These and other embodiments can each optionally include one or more of the following features.

In some embodiments of the invention, the power line measurement device comprises a fixed jaw and the movable jaw.

In some embodiments of the invention, the movable jaw of the power line measurement device is configured to grip onto the electrical power line and/or the splice based on a movement upon the electrical power line.

In some embodiments of the invention, the power line measurement device comprises a prism that displays the measurement data to be viewed by a camera of the UAV.

In some embodiments of the invention, the power line measurement device comprises a mirror that displays the measurement data to be viewed by a camera of the UAV.

In some embodiments of the invention, the power line measurement device comprises a digital caliper that includes a digital display screen.

In some embodiments of the invention, the apparatus further comprises one or more corona rings coupled to the power line measurement device.

In some embodiments of the invention, the power line measurement device comprises a linear probe coupled to a pair of jaws in an inner vertex formed between the pair of jaws.

In some embodiments of the invention, the at least one attachment line comprises flexible dielectric connection lines.

In some embodiments of the invention, the deployment apparatus includes a main bar, a mounting adapter, and a crossbar affixed perpendicularly to the main bar via the mounting adapter.

In some embodiments of the invention, the plurality of attachment lines comprises a first, a second, and a third attachment line, the first attachment line is connected to a first end of the crossbar, the second attachment line is connected to a second end of the crossbar, and a third attachment line is connected a back end of the main bar.

In some embodiments of the invention, the power line measurement device comprises a pair of guide rods attached to an attachment bracket.

In some embodiments of the invention, each guide rod comprises a weight located at a distal end of each guide rod, weighted material within each guide rod, or a combination thereof.

In some embodiments of the invention, the support frame further comprises a plurality of flexible dielectric support lines.

In some embodiments of the invention, a length of each of the flexible dielectric support lines is based on an electromagnetic field of the electrical power line. In some embodiments of the invention, a length of each of the flexible dielectric support lines is adapted to be selected based on a voltage of the electrical power line.

In some embodiments of the invention, the apparatus comprises a nonconductive payload system (NPS). In some embodiments of the invention, the NPS comprises the upper frame, the lower frame, and the attachment lines.

In some embodiments of the invention, the apparatus further includes the UAV.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The accompanying drawings, which are incorporated in and constitute a part of this specification, illustrate various embodiments of the present invention and, together with the general description of the invention given above, and the detailed description of the embodiments given below, serve to explain the embodiments of the invention. In the drawings, like reference numerals are used to indicate like parts in the various views.

FIG. 1 is a perspective view of a system for a power line diameter measuring device for use with an aerial system for performing work on electrical power lines, in accordance with embodiments of the present invention.

FIGS. 2A-2E illustrate different views of using a power line diameter measuring device, in accordance with embodiments of the present invention.

FIG. 3 illustrates a view of using a power line diameter measuring device of FIGS. 2A-2E with the aerial system of FIG. 1.

FIGS. 4A-4C illustrate different views of using a power line diameter measuring device with an optional viewing prism, in accordance with embodiments of the present invention.

FIGS. 5A-5C illustrate different views of a power line diameter measuring device with an optional viewing mirror, in accordance with embodiments of the present invention.

FIG. 6 illustrates a view of using a power line diameter measuring device of FIGS. 4A-4C with the aerial system of FIG. 1.

FIGS. 7A and 7B illustrate different views of a power line diameter measuring device with optional corona rings, in accordance with embodiments of the present invention.

FIG. 8 illustrates a view of using a power line diameter measuring device of FIGS. 7A and 7B with the aerial system of FIG. 1.

FIG. 9 illustrates a view of a power line diameter measuring device using a linear sensor, in accordance with embodiments of the present invention.

FIG. 10 illustrates a view of using a power line diameter measuring device of FIG. 9 with the aerial system of FIG. 1.

### DETAILED DESCRIPTION

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

The present invention relates, in some aspects and in accordance with some embodiments, to one or more devices for measuring a diameter of live power lines (such devices are referred to herein as power line measurement devices) via a UAS carrying a Nonconductive Payload System (NPS). The power line measurement devices may generally include a class of monitoring devices that attach to a power line, so that one or more characteristics of the power line may be measured (e.g., a diameter). Different attachment systems may be utilized for attaching a power line measurement device, such as a modified caliper, to a UAS. The different attachment systems, and methods of using the same, are described herein.

Embodiments of the invention may include the use of an unmanned aerial vehicle (UAV or drone) to carry power line repair or inspection tools and lower such tools onto an energized power line. The power line diameter measuring device of embodiments of the invention may be used with such an aerial system. Embodiments of the invention may comprise power line diameter measuring devices as described herein, methods of measuring the diameter of a power line using such devices, and systems for power line diameter measurement comprising such devices along with the unmanned aerial systems (UAV and/or support frame). The power line diameter measuring device for use with an aerial system may include a modified digital caliper, a linear sensor, or the like, that can be lowered down onto a live power line. Additionally, embodiments of the invention may include various options for a user to obtain the diameter reading from the digital caliper, linear sensor, or other sensor(s) to an electronic device via data communications (e.g., sending the digital measurement data, sending an image from a camera of the UAV of a digital readout, or by other means for delivering measurement data).

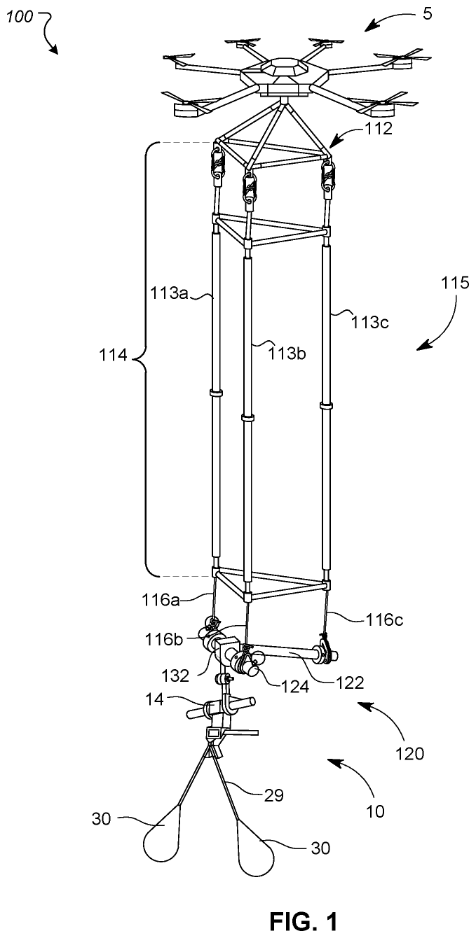

FIG. 1 illustrates a system 100 for using a power line diameter measuring device 10 on a power line. The system 100 includes an unmanned aerial system (UAS) 10 and a NPS 115. The UAS 5 may be referred to as a drone, and sometimes referred to as an unmanned aerial vehicle (UAV). The NPS 115 includes an upper frame 112 that may be releasably attachable to the UAS 5 and a lower frame 114, and a deployment apparatus 120 carrying the power line diameter measuring device 10 that is selectively attachable to the lower frame 114 of the NPS 115. For example, the UAS 5 and the NPS 115 enable the deployment apparatus 120 and the power line diameter measuring device 10, to be efficiently carried to an active electrical power line and positioned for deployment, as described herein. Three attachment lines 16a, 16b, 16c extend from the lower end of the NPS 115 and are attachable to the deployment apparatus 120. The lower frame 114 includes three dielectric support lines 113a, 13b, 13c that are connected between a lower and upper portion of the lower frame 114, and may be adjustable in length. Although three attachment lines 16a-c and three support lines 113a-c are shown, more or fewer lines may be used, however, fewer cables may not provide stable support for the UAS 5 or the power line diameter measuring device 10 during flight.

The deployment apparatus 120 includes a main bar 122 that runs generally front-to-back (as determined by the general forward flight direction of the UAS) with a crossbar 124 affixed generally perpendicularly to the main bar 122. The deployment apparatus 120 is supported by the NPS 115 by attaching one attachment line 16a, 16b to each end of the crossbar 124 and one attachment line 16c to the back end of the main bar 122 using any suitable mechanism or method of attachment.

In order for the power line tool to perch stably on the power line, the center of gravity of the power line tool must be lower than the power line upon which the power line tool is perched. Elongated, weighted guides are preferably mounted to the angled distal ends of the fixed jaw 28 and the movable jaw 30. The weight of such guides provides ballast to help lower the center of gravity of the power line diameter measuring device 10. The weight of such guides helps cause the caliper jaws to open as the device sits on a power line. A slight rocking motion may be imparted to the device to also help cause the caliper jaws to open as the device sits on a power line. In an exemplary embodiment, and as illustrated, the power line diameter measuring device 10 may include guide rods 29. The guide rods 29 may include weights 30. As illustrated, the weights 30 are teardrop shaped weights and located at the distal ends of the guide rods 29. Additionally, or alternatively, in some embodiments different weighted elements may be used (e.g., using solid matter inside the rods 29 such as solid copper rods for the guide rods 29). The weights 30 help stabilize the entire assembly during flight and the teardrop shapes may help minimize snagging on power lines or any other obstacles. The guide rods are positioned on the power line diameter measuring device 10 to provide the desired position, as the positioning and angle of the guide rods 29 aids in the utilization of the power line diameter measuring device onto a power line for measurement, as further described herein.

The power line diameter measuring device 10 includes an adapter to connect to a mounting adapter 132 of the deployment apparatus 120 for attaching the power line diameter measuring device 10 to the UAS 5 and the NPS 115. The mounting adapter 132 may, as in the illustrated embodiment, also function as the connector between the main bar 122 and the crossbar 124. The mounting adapter 132 has a cooperative hot stick-type attachment point to engage with the hot stick attachment point of the installation adapter. The other components of the power line diameter measuring device 10 are further described herein.

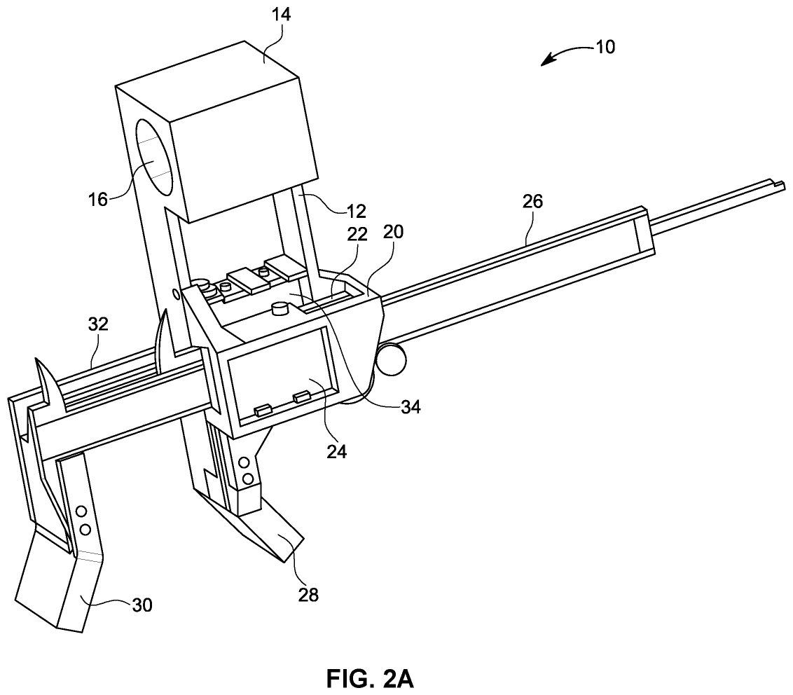

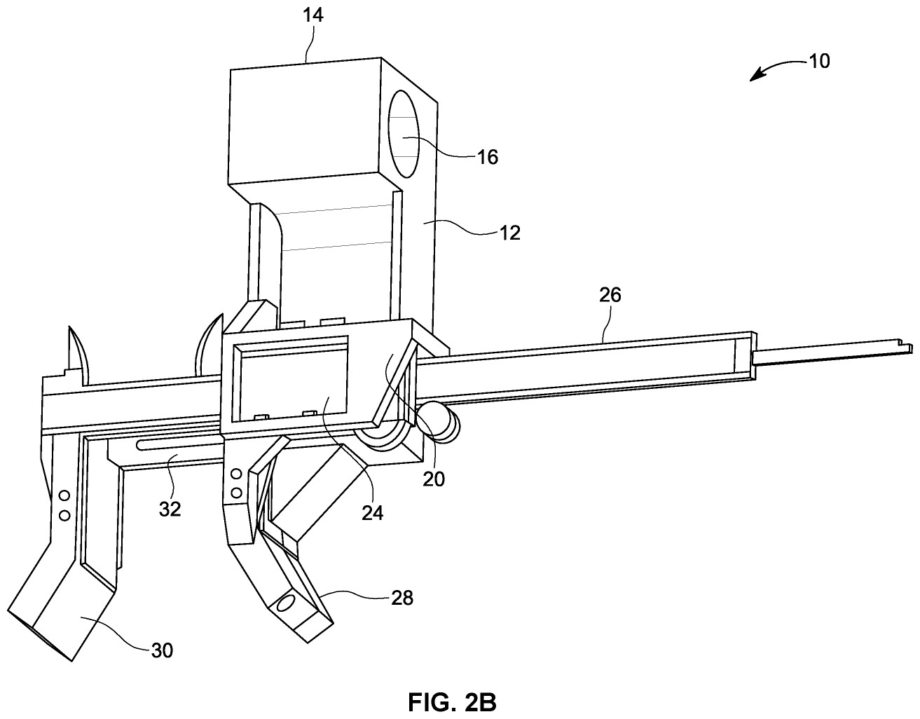

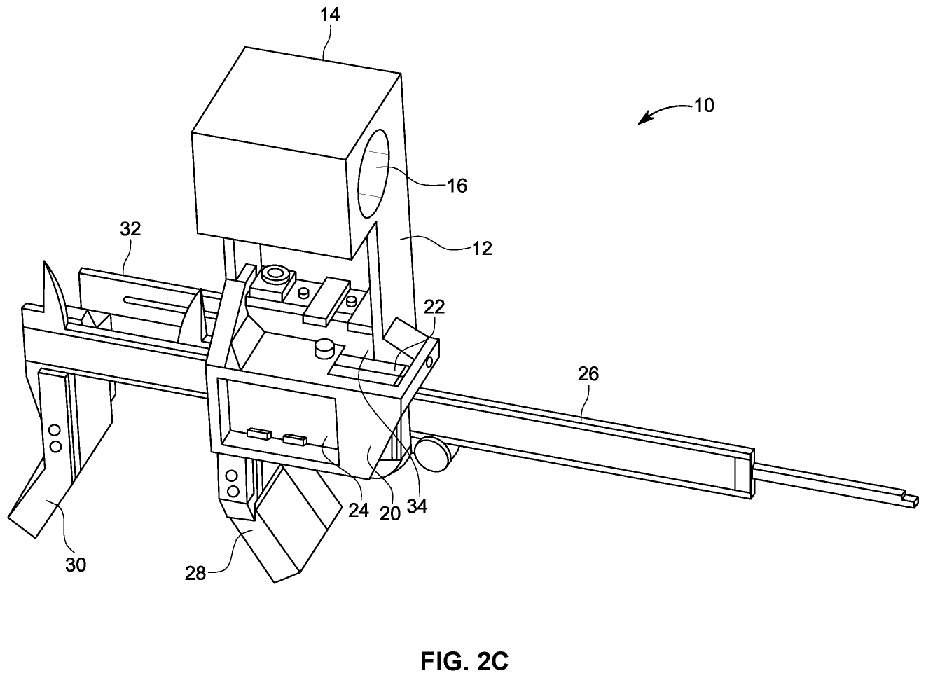

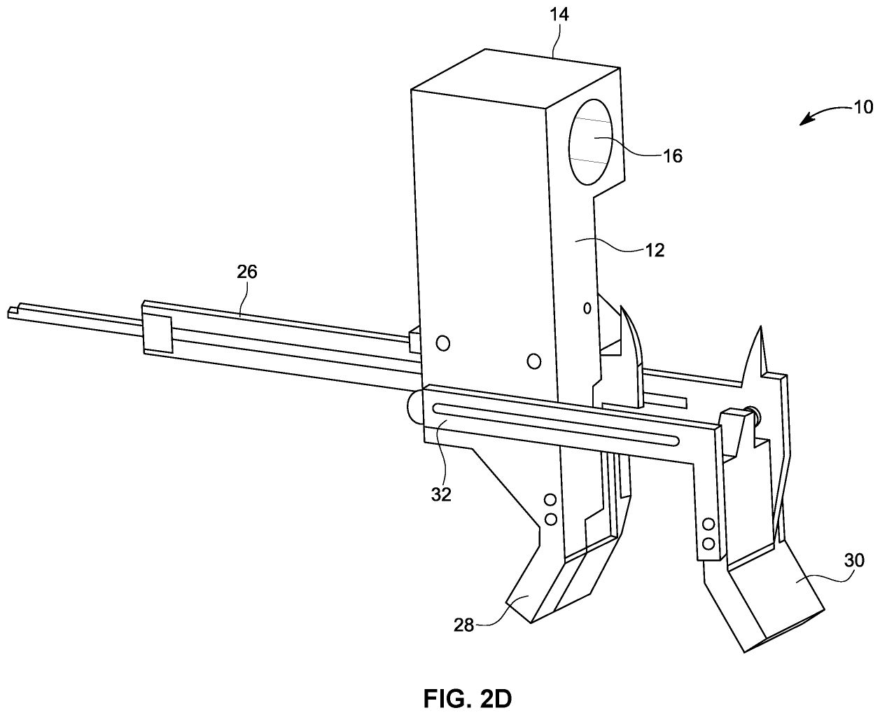

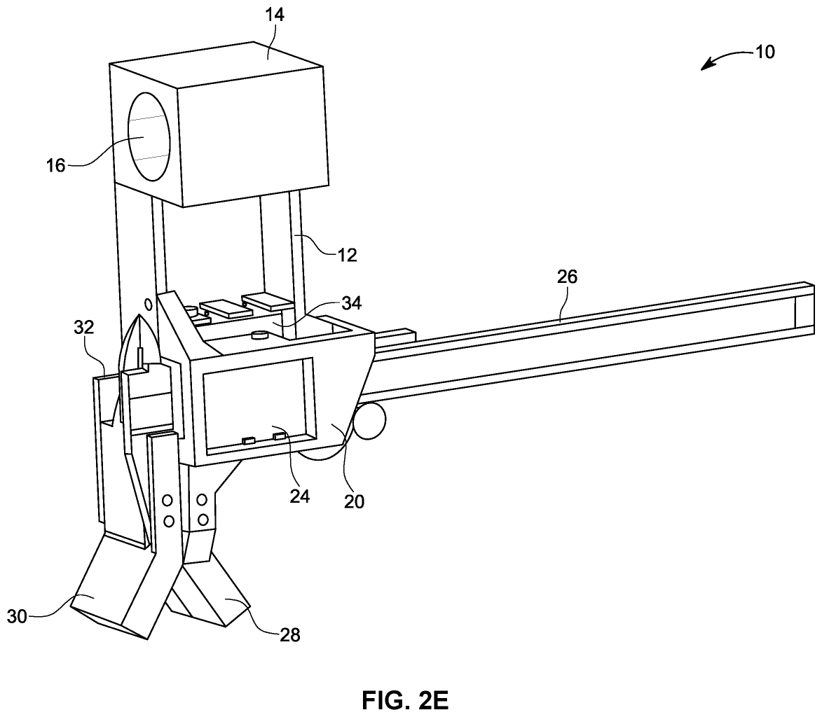

FIGS. 2A-2E illustrate different views of the power line diameter measuring device 10. The power line diameter measuring device 10 comprises a housing 12. An upper housing portion 14 has a through-hole 16 for mounting the device 10 to cables, ropes, frame etc. to enable the device to be carried below a UAV (not illustrated). In the illustrated embodiment, a cross bar (e.g., cross bar 124, not illustrated in FIG. 2) is inserted through hole 16 to provide opposing front-left and front-right attachment points for support cables or the like. In some implementations, another bar may be inserted into a cross section hole to provide a center-rear attachment point (not illustrated) for a support cable or the like, thereby providing a three-point attachment for carrying the device below a UAV. Any other suitable support/carrying device/mechanism/method may be used.

A caliper control box 22 is secured to the housing 12. The caliper control box 22 interfaces with a slidable caliper arm 26 to obtain a digital measurement of the distance between a fixed caliper jaw 28 and a movable caliper jaw 30 when an item to be measured is placed between the jaws. In the power line diameter measuring device 10 of embodiments of the invention, the caliper jaws are enlarged (relative to a conventional digital caliper) and have outwardly angled distal jaw ends to better enable the device to settle down on a power line such that the power line enters the measuring space between the fixed jaw 28 and the movable jaw 30. In a preferred embodiment, the fixed jaw 28 and the movable jaw 30 are comprised entirely or partially constructed of carbon fiber for its strength, its light weight, and its electrical conductivity (the conductivity is desirable for preventing charge from concentrating at the pointed tips of the jaws and for directing charge into any attached corona rings), however any suitable material may be used. The caliper control box 22 has a display screen 24 (typically LCD) for displaying the obtained measurement. The movable jaw 30 is slidable between a closed position (seen in FIG. 2E) and an open position (seen in the FIGS. 2A-2D). The movable jaw 30 is biased toward the fixed jaw 28 using any suitable biasing mechanism (not illustrated), such as a spring or another linear biased gripping mechanism. The amount of biasing is carefully selected such that the jaws will open to receive the power line when the device is lowered onto the power line but will close against the power line to obtain an accurate measurement. Because the movable jaw 30 is larger than the movable jaw of a conventional digital caliper, a sliding support arm 32 is added parallel to the caliper arm 26 to provide additional support for the movable jaw 30.

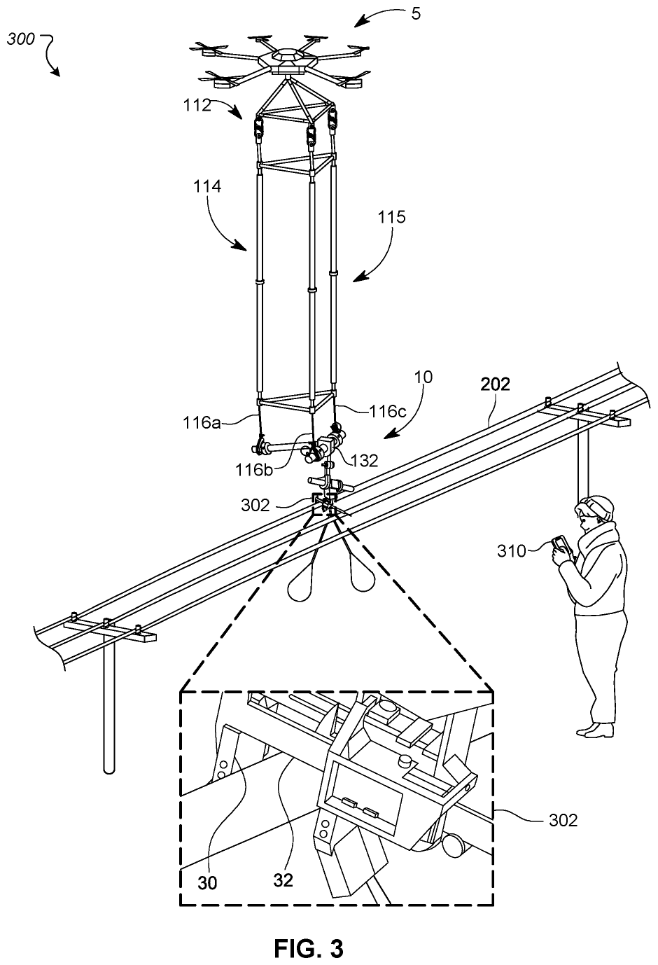

While an obtained measurement may be displayed on the display screen 24, it would be difficult or impossible for a user on the ground to read the display screen as the device sits on a power line. Thus, embodiments of the invention may comprise several different features to enable a user to obtain the measurement from the device. In the illustrated embodiment, the housing 12 holds a communication module 34. The communication module 34 receives the measurement from the caliper control box 22, typically via a hardwired connection (not illustrated). The communication module 34 may use any suitable wireless communication modality (e.g., Bluetooth, Wi-Fi, RF, etc.) to transmit the measurement to any desired location or device, such as directly to a receiving device held by a user or to the UAV which may relay the measurement to the receiving location/device. An example use case for is sending/receiving the measurement data from the communication module 34 of the power line diameter measuring device 10 to an electronic device is further described herein with reference to FIG. 3.

FIG. 3 illustrates a view of an operating environment 300 for using a power line diameter measuring device 10. In particular, FIG. 3 illustrates the system 100 of FIG. 1 (e.g., UAS 5, NPS 15, deployment apparatus 120, etc.) approaching and landing (e.g., latching, clamping, etc.) the power line diameter measuring device 10 (e.g., a modified caliper), onto or on top of the power line 202 via the UAS 5, as illustrated in the expanded area 302. Moreover, the power line diameter measuring device 10 is providing data (e.g., measurement data, such as a width measurement of the power line 202) to the electronic device 310 (e.g., via the communication module 34 as described herein). The power line diameter measuring device 10 may be configured for performing work (e.g., contact inspection, repair, or any other suitable work tasks that may be performed) on an electrical power line 202 and/or a splice on the electrical power line 202.

In implementations described herein, the power line diameter measuring device of embodiments of the invention described herein are intended to be used to measure the diameter of live, high-voltage power lines. Operating in such a high-voltage environment can create significant voltage differentials at different locations on the device that may negatively affect the operation of the device. As such, several different optional steps may be taken (alone or in combination) to counteract such issues. The metal caliper arm may be replaced by a non-conductive arm. A stronger ground connection may be made between the caliper structure and the transmitter circuitry, such as by adding one or more conductive screws and/or plates between the caliper structure and the transmitter circuitry.

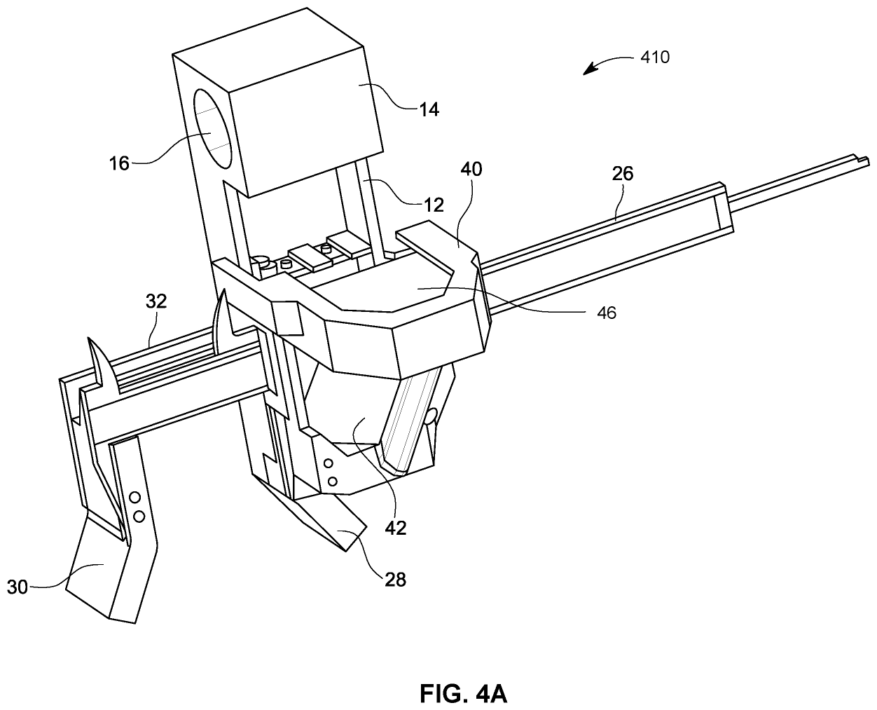

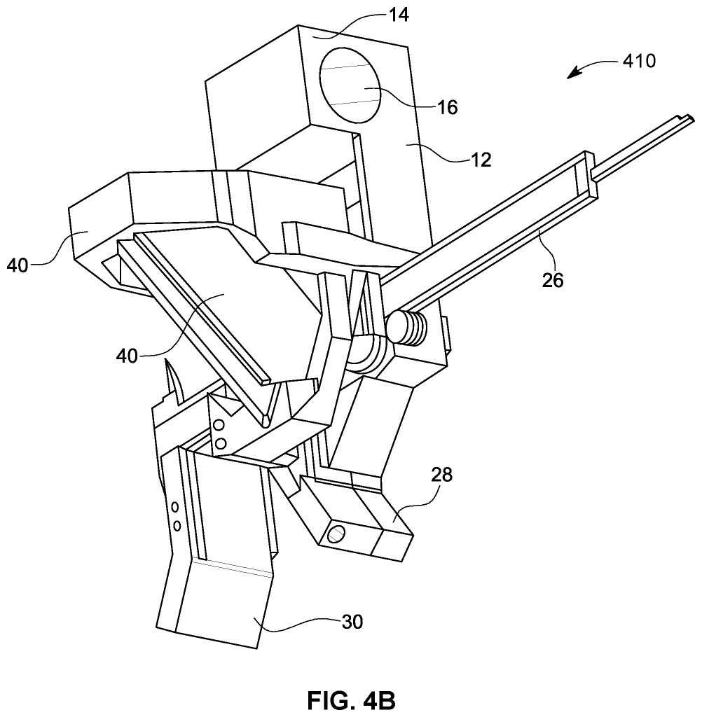

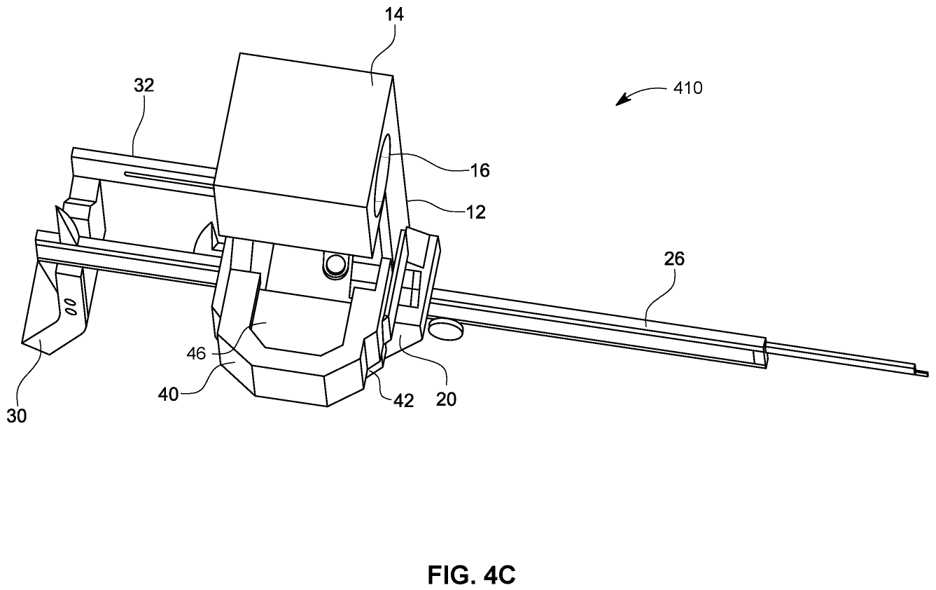

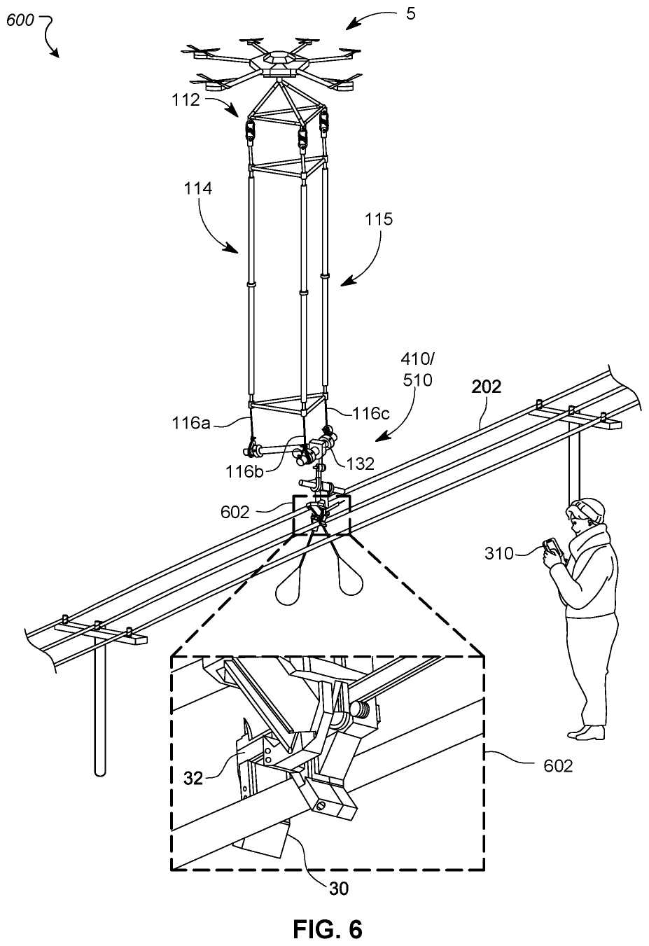

FIGS. 4A-4C illustrate different views of using a power line diameter measuring device 410 with an optional viewing prism 42, in accordance with embodiments of the present invention. A use case for using the power line diameter measuring device 410 is further illustrated herein with reference to FIG. 6. In particular, the power line diameter measuring device 410 of FIGS. 4A-4C may include the same components as power line diameter measuring device 10 of FIGS. 2A-2E, but further include a prism 42 and a bracket 40 on top of and covering the display screen 24 (not within view) in order to expand the display of the display screen 24. For example, in the embodiment of FIGS. 4A-4C, a prism 42 (e.g., an Amici prism) is held in place adjacent to the display screen 24 by a retention bracket 40. When a vertical face (not illustrated) of the prism 42 is positioned adjacent the display screen 24, the numbers on the display screen 24 may be visible on a horizontal face 46 of the prism 42. A camera (not illustrated) on the UAV pointing down at the power line diameter measuring device 410 would be able to view and capture the image on the horizontal face 46 and transmit the camera image to a user on the ground, as illustrated in FIG. 6. An optional light emitting diode (LED) or other suitable light (typically powered by a battery (not illustrated)) may be positioned against a side of the prism 42 to illuminate the interior of the prism 42, which can reduce or eliminate glare to increase visibility of the image on the horizontal face 46. Optionally, the display screen may be backlit, enlarged, or magnified to make the reading on the screen easier to see.

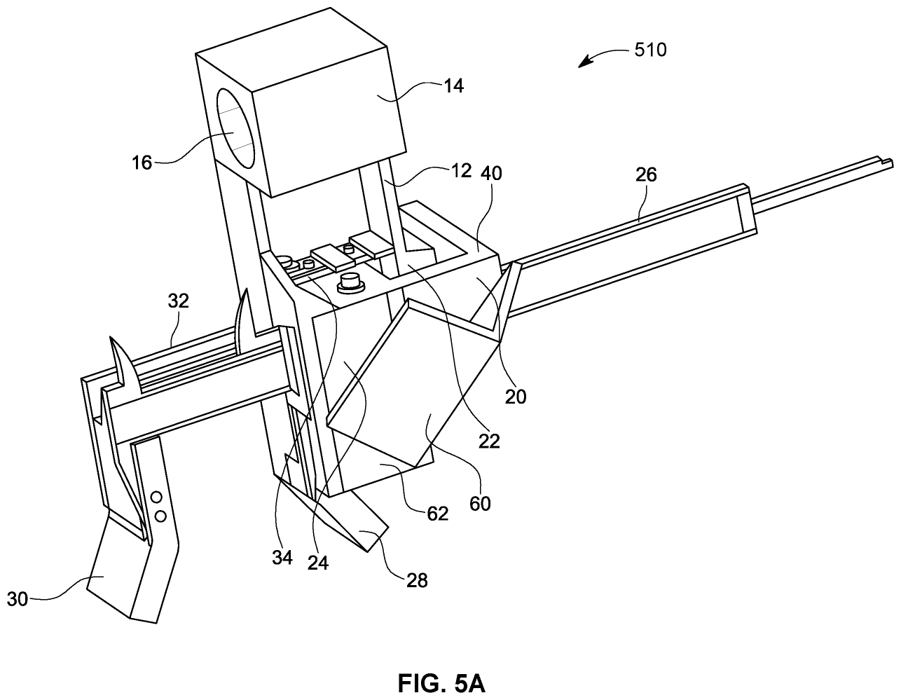

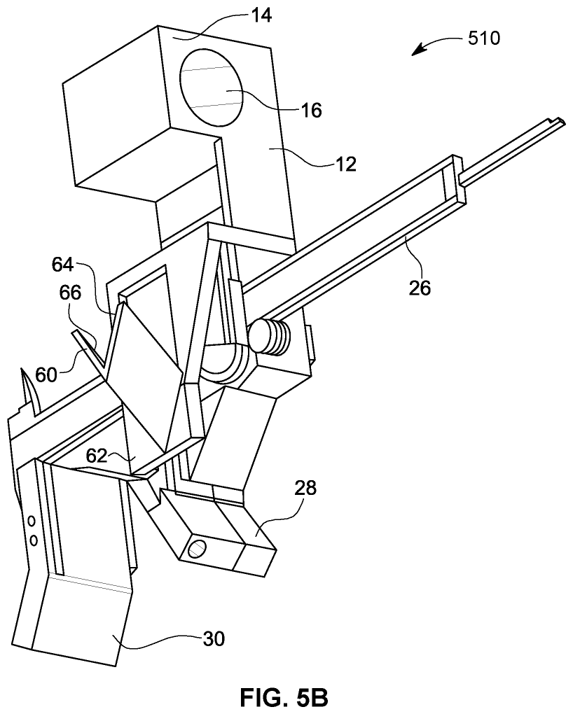

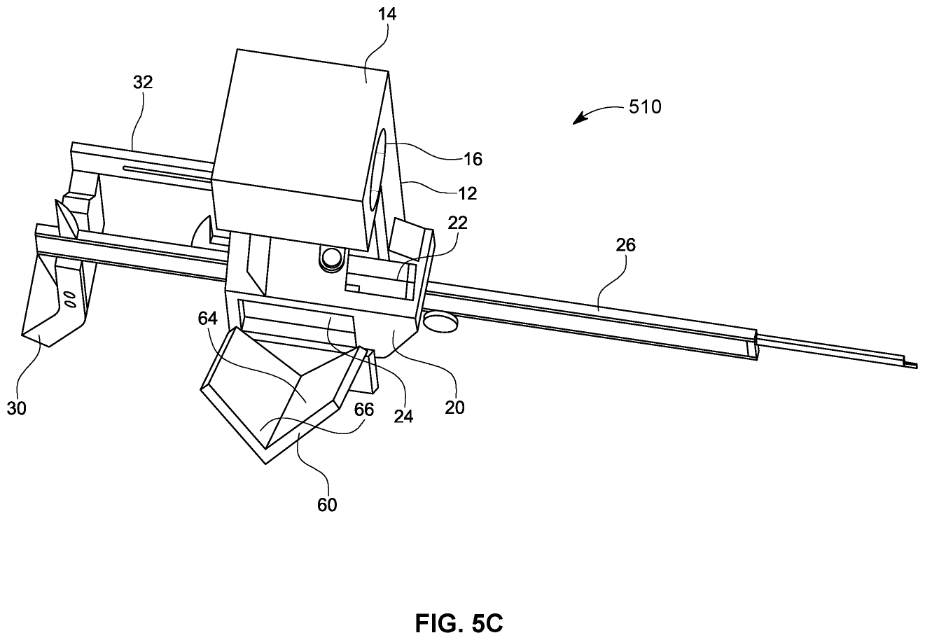

FIGS. 5A-5C illustrate different views of using a power line diameter measuring device 510 with an optional viewing mirror 60, in accordance with embodiments of the present invention. A use case for using the power line diameter measuring device 510 is further illustrated herein with reference to FIG. 6. In particular, similar to the power line diameter measuring device 410 of FIGS. 4A-4C, the power line diameter measuring device 510 of FIGS. 5A-5C may include the same components as power line diameter measuring device 10 of FIGS. 2A-2E, but further include a non-reversing mirror 60 and a mounting plate 62 on top of and covering the display screen 24 (not within view) in order to expand the display of the display screen 24. For example, a non-reversing mirror 60 is held in place adjacent but below the display screen 24 by a mounting plate 62. The non-reversing mirror 60 includes a first mirror 64 and a second mirror 66 which are affixed to each other at a right angle along a common edge. The non-reversing mirror 60 reflects a true (e.g., non-reversed) image of the display screen 24 upward such that a camera (not illustrated) on the UAV 5 pointing down at the power line diameter measuring device 510 would be able to view and capture the image on the non-reversing mirror 60 and transmit the camera image to a user on the ground, as illustrated in FIG. 6.

FIG. 6 illustrates a view of an operating environment 600 of using a power line diameter measuring device 410 of FIGS. 4A-4C with the aerial system of FIG. 1. In particular, FIG. 6 illustrates the system 100 of FIG. 1 (e.g., UAS 5, NPS 15, deployment apparatus 120, etc.) approaching and landing (e.g., latching, clamping, etc.) the power line diameter measuring device 410 (e.g., a modified caliper), onto or on top of the power line 202 via the UAS 5, as illustrated in the expanded area 602. Alternatively, the power line diameter measuring device 510 of FIGS. 5A-5C may be used in lieu of power line diameter measuring device 410. The power line diameter measuring device 410 or 510 may be configured for performing work (e.g., contact inspection, repair, or any other suitable work tasks that may be performed) on an electrical power line 202 and/or a splice on the electrical power line 202. Moreover, and similar to operating environment 300 of FIG. 3, the power line diameter measuring device 410/510 may be providing data (e.g., measurement data, such as a width measurement of the power line 202) to the electronic device 310. However, operating environment 600 provides the measurement data to the electronic device 310 for a use to see via a captured image from the UAV 5 pointing down at a reflection of the measurement data from the display screen 24 via the horizontal face 46 of prism 62 of the power line diameter measuring device 410 or the reflection of the display screen 24 upon the first mirror 64 and the second mirror 66 of the non-reversing mirror 60 of the power line diameter measuring device 510. Additionally, or alternatively, in some implementations, a separate electronic readout positioned upwards or a modification of the caliper to face the display towards the UAS' camera.

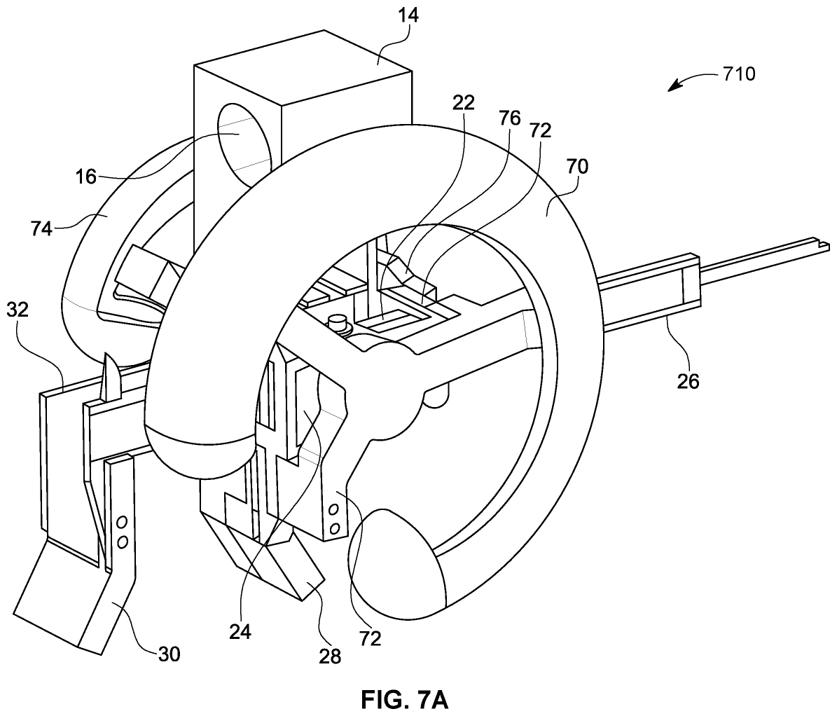

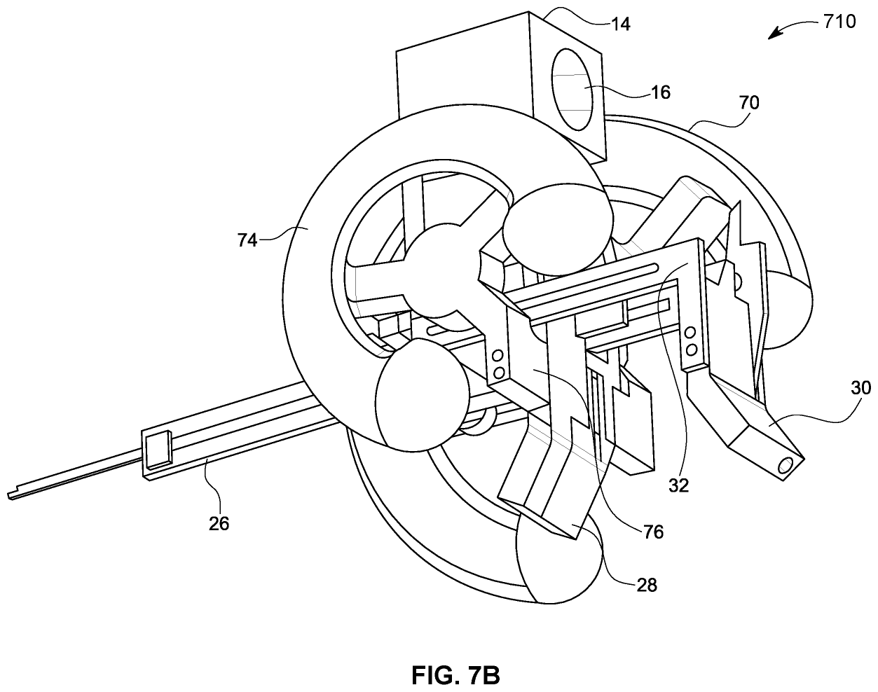

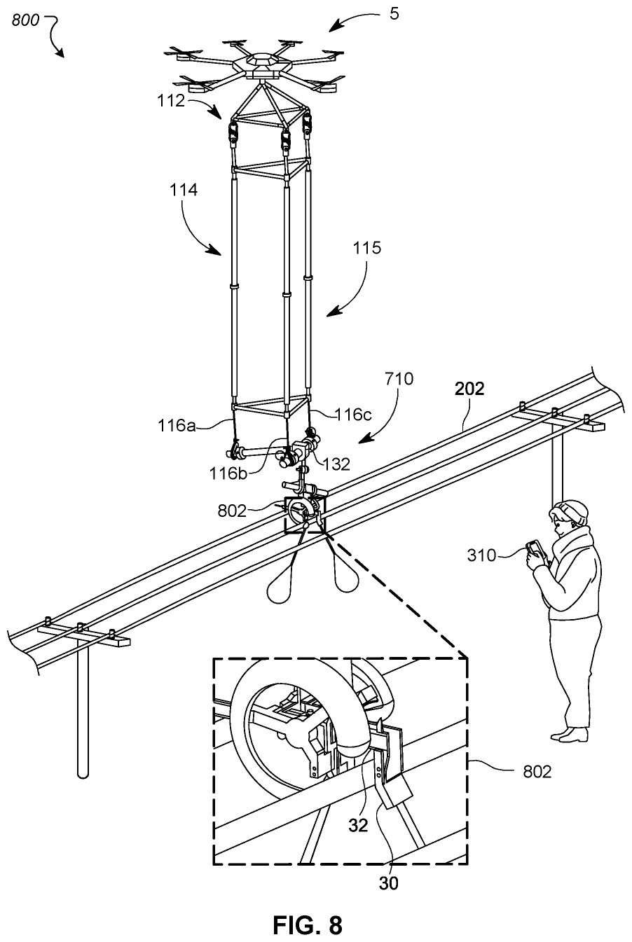

FIGS. 7A, 7B illustrate different views of a power line diameter measuring device 710 with optional corona rings 70, 74, in accordance with embodiments of the present invention. A use case for using the power line diameter measuring device 710 is further illustrated herein with reference to FIG. 8. In particular, the power line diameter measuring device 710 of FIGS. 7A-7B may include the same components as the power line diameter measuring device 210 of FIGS. 2A-2E, but further include one or more corona rings that may be mounted on the power line diameter measuring device 710 to counteract operating in such a high-voltage environment. For example, a first corona ring 70 may be mounted (via mounting brackets 72) to the front of the power line diameter measuring device 710, and a second corona ring 74 may be mounted (via mounting brackets 76) to the rear of the power line diameter measuring device 710. The corona rings 70, 74 may be constructed of any suitable electrically-conductive material, such as carbon fiber or copper mesh. Rather than their typical use preventing corona, embodiments of the invention use corona rings to minimize the electric field around the electronics by concentrating the electrical charge on the rings.

FIG. 8 illustrates a view of an operating environment 800 for using a power line diameter measuring device 810. In particular, FIG. 8 illustrates the system 100 of FIG. 1 (e.g., UAS 5, NPS 15, deployment apparatus 120, etc.) approaching and landing (e.g., latching, clamping, etc.) the power line diameter measuring device 810 (e.g., a modified caliper), including the corona rings 70, 74, onto or on top of the power line 202 via the UAS 5, as illustrated in the expanded area 802. Moreover, the power line diameter measuring device 710 is providing data (e.g., measurement data, such as a width measurement of the power line 202) to the electronic device 310 (e.g., via the communication module 34 as described herein). The power line diameter measuring device 710 may be configured for performing work (e.g., contact inspection, repair, or any other suitable work tasks that may be performed) on an electrical power line 202 and/or a splice on the electrical power line 202.

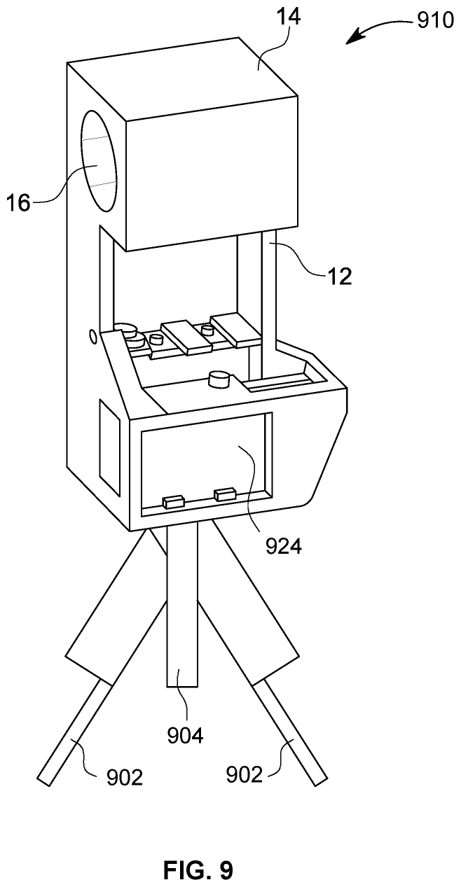

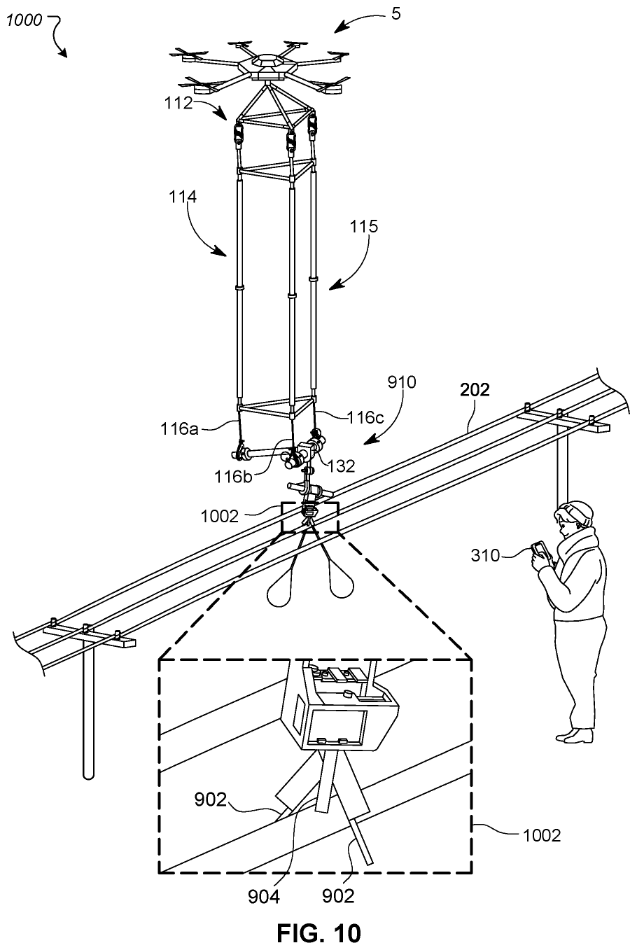

FIG. 9 illustrates a view of a power line diameter measuring device 910 using a linear sensor 904, in accordance with embodiments of the present invention. A use case for using the power line diameter measuring device 910 is further illustrated herein with reference to FIG. 10. The power line diameter measuring device 910 of FIG. 9 may include some of the same components as the power line diameter measuring device 710 of FIGS. 2A-2E but would not require as many components based on the different method of capturing the measurement data (e.g., a width of a power line). For example, FIG. 9 illustrates an alternative embodiment of a power line diameter measuring device than previously described herein for use with an aerial system for performing work on electrical power lines. The power line diameter measuring device 910 of FIG. 9 comprises generally V-shaped jaws 902 which open downward when the power line diameter measuring device 910 is in use. The angle of the jaws 902 is known. At the top center where the two sides of the jaws 902 meet (i.e., the inner vertex), a downwardly pointing linear probe 904 (e.g., a linear sensor) is mounted.

FIG. 10 illustrates a view of an operating environment 1000 for using a power line diameter measuring device 910. In particular, FIG. 10 illustrates the system 100 of FIG. 1 (e.g., UAS 5, NPS 15, deployment apparatus 120, etc.) approaching and landing (e.g., lowering, etc.) the power line diameter measuring device 910 (e.g., a linear sensor), onto or on top of the power line 202 via the UAS 5, as illustrated in the expanded area 1002. As the power line diameter measuring device 910 is lowered down onto a power line by the UAS 5, the power line 202 enters the space between the two sides of the jaws 902 and displaces the linear probe 904 (e.g., moves up). The power line 202 may continue to further displace the linear probe 904 upward until the power line 202 contacts both sides of the jaws 902 and cannot move further upward (i.e., toward the vertex) due to the size of the power line. A smaller diameter power line will be able to move relatively further into the jaws 902 and therefore cause a relatively greater displacement of the linear probe 904, while a larger diameter power line will be able to move relatively less far into the jaws 902 and therefore cause a relatively lesser displacement of the linear probe 904. Once the power line contacts both sides of the jaws 902 and cannot move further upward due to the size of the power line, the displacement of the linear sensor 104 is determined. By knowing how far the distal end of the linear probe 904 projected into the space within the jaws 902 initially and by determining the displacement of the linear probe by the power line, it can be determined how far the distal end of the linear probe 904 projects into the space within the jaws 902 when displaced by the power line. This displaced distance corresponds to the distance between the inner vertex of the jaws 902 and the closest point of the perimeter of the power line. By knowing the distance between the inner vertex of the jaws 902 and the power line and knowing the angle of the jaws 902, the diameter of the power line is readily calculated using trigonometry and geometry. Moreover, the power line diameter measuring device 910 may be providing data (e.g., measurement data, such as a width measurement of the power line 202) to the electronic device 310 (e.g., via the communication module 34 as described herein).

Embodiments of the invention may further include methods for using a UAS 5 to deliver and land a tool or similar device (e.g., power line diameter measuring device 10) on an electrical power line and/or on a splice on an electrical power line, while the UAS 5 maintains flight and does not itself land on the power line and/or splice. Such methods may include some or all of the following steps. The airborne portion of the system (such as NPS 115 and UAS 5, as illustrated in FIGS. 1 and 3) may be assembled and readied for use. For the airborne portion (e.g., UAS 5 connected to the NPS 115), a support frame (e.g., upper frame 112) may be attached to a UAS 5 via a payload release mechanism, and a deployment apparatus 120 may be attached to the lower frame 114 of the NPS 115 via a plurality of flexible dielectric attachment lines 16a, 16b, and 16c connecting the lower frame 114 to the deployment apparatus 120. In some implementations, the plurality of flexible dielectric attachment lines 16a, 16b, and 16c may be dielectric hollow tubes. A power line diameter measuring device 10 may be attached to the installation adapter 44 of the deployment apparatus 120. When airborne, the power line diameter measuring device 10 may be activated.

To place the power line diameter measuring device 10 (or the like) using the systems and methods of embodiments of the invention, the power line diameter measuring device 10 may be attached to an installation adapter, which in turn may be attached to the mounting adapter 132 of the deployment apparatus 120. In some embodiments, the power line diameter measuring device 10 may be attached to the attachment lines 16a-c of the NPS 115, and the upper frame 112 of the NPS 115 may be attached to the UAS 5. In other words, each of the attachment lines 16a-c are attached to a corresponding attachment point on the support frame (e.g., lower frame 114 and upper frame 112) of the NPA 15, and a corresponding attachment point on the power line diameter measuring device 10. The UAS 5 takes off and flies toward the installation location. The UAS 5 may be piloted to position the deployment apparatus 120 such that the guide rods 29 contact the power line. The UAS 5 reduces thrust to guide and drop the power line diameter measuring device 10 onto the power line, activating a linear biased gripping mechanism which clamps a power line diameter measuring device to the power line.

The UAS 5 may be piloted to a position adjacent to and higher than the electrical power line 202 and/or a splice on an electrical power line 202 upon which it is desired to use the power line diameter measuring device 10. The UAS 5 may be piloted laterally until the guide rods 29 of the deployment apparatus 120 contact the power line and/or the splice. The altitude of the UAS 5 may be reduced to lower the power line diameter measuring device 10 onto the power line and/or the splice such that the power line diameter measuring device 10 may be perched or connected on the power line and/or the splice. The altitude of the UAS 5 may be further reduced to introduce slack into the support lines (e.g., the plurality of flexible dielectric support lines 113a-c), which helps prevent small in-flight movements of the UAS 5 from pulling the power line diameter measuring device 10 off the line. While the power line diameter measuring device 10 is perched on the line and the UAS 5 is hovering, the power line diameter measuring device 10 may perform whatever action (e.g., measurement, inspection, etc.) that it is designed to perform. If the power line diameter measuring device 10 needs to be repositioned on the power line to perform its work, the UAS 5 may be piloted appropriately to drag or lift and move the power line diameter measuring device 10 to a new position to continue/complete the work.

If there is an emergency while the power line diameter measuring device 10 is perched on the power line 202, the UAS 5 pilot may activate a payload release mechanism to detach the support frame from the UAS 5. The support frame will fall to the ground and may pull the power line diameter measuring device 10 off the power line 202 so that the power line device may also fall to the ground (e.g., if not clamped on to the power line 202). The combined weight may be sufficient to pull the deployment apparatus 120 off the line, but if the power line diameter measuring device 10 is connected (e.g., clamped) on the line when the payload release is activated, the power line diameter measuring device 10 may be disconnected from the installation adapter 44 and left on the line. Actuation of the release mechanism may also be a standard part of the recommended landing procedure.

In some embodiments of the invention, a system (e.g., system 100) may be utilized for performing work (including measurement, contact inspection, repair, or any other suitable work tasks that may be performed) on an electrical power line and/or a splice on the electrical power line. The system may comprise an unmanned aerial vehicle (UAV) (e.g., UAS 5), a power line tool (e.g., power line diameter measuring device 10) adapted to perch on the power line and/or the splice, a support frame (e.g., upper frame 112 and lower frame 114) selectively releasably attached to the UAV, a plurality of flexible dielectric support lines as part of the support frame (e.g., support lines 113a-c), and a plurality of flexible dielectric attachment lines (e.g., attachment lines 16a-c) attaching the power line tool to the support frame. Although three attachment lines 16a-c are shown, although more or fewer may be used; however fewer cables may not provide stable support for the tool during flight). Each of the support attachment lines may be attached to a corresponding attachment point on the support frame (e.g., the lower portion of lower frame 114) and a corresponding attachment point on the power line tool (e.g., attachment points on the crossbar 124 or main bar 122).

The UAV may be any suitable remotely piloted aircraft, typically multi-rotor, with sufficient payload capacity to carry the support frame, support lines, and power line tool. In the illustrated embodiments, UAV comprises a main body and six rotors supported by corresponding rotor support arms (any suitable number of rotors may be used). As is conventionally known, the UAV may be controlled in flight by an operator or pilot using a controller (not illustrated). The UAV may have retractable landing gear (not illustrated).

In the illustrated embodiments, a support frame (e.g., upper frame 112) may be generally pyramidal, providing two front attachment points and one rear attachment point for the support lines. However, any suitable support frame structure may be used. Having at least three attachment points provides more stability to the tool during flight than having only one or two attachment points. The number, position, and arrangement of the attachment points may vary. The support lines may be attached to the support frame in any suitable manner or with any suitable mechanism, and may be removably attached or fixedly attached. The support frame may be constructed from any suitable material or combination of materials that is sufficiently strong, sufficiently rigid, and sufficiently lightweight, such as carbon fiber or any suitable polymer. It may be optimal to have no support frame beyond flexible cables or ropes terminating at a single central UAV attachment flange.

A support frame (e.g., upper frame 112) includes a UAV attachment flange. The UAV attachment flange may be generally aligned with the central front-to-back axis of the support frame. The UAV attachment flange may be configured to mate with a payload release mechanism that may be mounted to the underside of the main body of the UAV to enable releasable attachment of the support frame to the UAV. In one exemplary embodiment of the invention, the payload release mechanism comprises any suitable payload release mechanism. The payload release mechanism may have a movable pin that selectively engages with the hole in the UAV attachment flange. The pin engages with the hole in the UAV attachment flange to couple the support frame and the UAV during normal operation of the system and disengages to release the support frame from the UAV at the end of a mission or in an emergency. The thickness of the UAV attachment flange may be selected to enable the support frame to pitch relative to the UAV but to somewhat limit yaw and roll of the support frame relative to the UAV as the UAV pitches, yaws, and rolls during flight (some yaw and roll of the support frame is acceptable to limit yaw and roll of the support frame from transferring to the UAV). The payload release mechanism may be controlled by the UAV operator.

The support lines (e.g., support lines 113a-c or attachment lines 16a-c) may comprise any suitably strong and flexible material, such as ropes (natural or synthetic), metallic cables, wires, etc. In one exemplary embodiment of the invention, the support lines comprise Hy-Dee-Brait Hot Rope from Yale Cordage. The material selected for the support lines is typically a non-conductive (dielectric) material to prevent electricity from being conducted up the support lines to the UAV. Although it may be possible to electrically shield the critical components of the UAV, it may be desirable that the length of the support lines be long enough to maintain a sufficient distance between the UAV and the power line to prevent damage to the UAV from the electromagnetic fields surrounding such high-voltage power lines. In this regard, the length of the support lines may be selected based on the voltage of the power line upon which the tool (e.g., power line diameter measuring device 10, or the like) is to be perched (based on the live-line work approach distances set forth in the National Electrical Safety Code). In most cases there is some charge in the shield line which runs above the energized phases, so the UAV should be kept above those.

Importantly, in systems and methods of embodiments of the invention, the power line tool that is suspended from the UAV may be lowered onto a power line and/or splice while the UAV hovers safely apart from the power line and preferably outside a bound of undesirable intensity of the electromagnetic field. The power line tool may comprise any suitable tool for inspecting, repairing or otherwise performing work on a power line, splice, or other component of a high voltage electrical power system. In the illustrated embodiment, the power line tool comprises a conductor measurement device or diameter measurement.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus comprising:
a deployment apparatus releasably attached to a power line measurement device at one or more points, wherein the power line measurement device is configured to determine measurement data by measuring a width of a live electrical power line and/or a splice on the electrical power line;
a support frame configured to be selectively and releasably coupled to an unmanned aerial vehicle (UAV); and
at least one attachment line connecting the deployment apparatus to the support frame.

2. The apparatus of claim 1, wherein the power line measurement device comprises a fixed jaw and the movable jaw.

3. The apparatus of claim 2, wherein the movable jaw of the power line measurement device is configured to grip onto the electrical power line and/or the splice based on a movement upon the electrical power line.

4. The apparatus of claim 1, wherein the power line measurement device comprises a prism that displays the measurement data to be viewed by a camera of the UAV.

5. The apparatus of claim 1, wherein the power line measurement device comprises a mirror that displays the measurement data to be viewed by a camera of the UAV.

6. The apparatus of claim 1, wherein the power line measurement device comprises a digital caliper that includes a digital display screen.

7. The apparatus of claim 1, wherein the apparatus further comprises one or more corona rings coupled to the power line measurement device.

8. The apparatus of claim 1, wherein the power line measurement device comprises a linear probe coupled to a pair of jaws in an inner vertex formed between the pair of jaws.

9. The apparatus of claim 1, wherein the at least one attachment line comprises flexible dielectric connection lines.

10. The apparatus of claim 1, wherein the deployment apparatus comprises:
a main bar;
a mounting adapter; and
a crossbar affixed perpendicularly to the main bar via the mounting adapter.

11. The apparatus of claim 10, wherein:
the plurality of attachment lines comprises a first, a second, and a third attachment line;
the first attachment line is connected to a first end of the crossbar;
the second attachment line is connected to a second end of the crossbar; and
a third attachment line is connected a back end of the main bar.

12. The apparatus of claim 1, wherein the power line measurement device comprises a pair of guide rods attached to an attachment bracket.

13. The apparatus of claim 12, wherein each guide rod comprises a weight located at a distal end of each guide rod, weighted material within each guide rod, or a combination thereof.

14. The apparatus of claim 1, wherein the support frame further comprises a plurality of flexible dielectric support lines.

15. The apparatus of claim 14, wherein a length of each of the flexible dielectric support lines is based on an electromagnetic field of the electrical power line.

16. The apparatus of claim 14, wherein a length of each of the flexible dielectric support lines is adapted to be selected based on a voltage of the electrical power line.

17. The apparatus of claim 1, wherein the apparatus comprises a nonconductive payload system (NPS).

18. The apparatus of claim 17, wherein the NPS comprises the upper frame, the lower frame, and the attachment lines.

19. The apparatus of claim 1, further comprising the UAV.

20. A method comprising:
attaching a power line measurement device to an unmanned aerial vehicle (UAV) via a deployment apparatus, wherein the power line measurement device comprises guide rods that extend below the power line device, wherein the deployment apparatus is connected to the UAV via a nonconductive payload system (NPS), wherein the power line device is adapted to latch onto an energized electrical power line and/or a splice on the energized electrical power line;
piloting the UAV to a first position adjacent to and at an altitude that is higher than an energized electrical power line and/or a splice on the energized electrical power line upon which it is desired to measure a width of the electrical the power line at a measurement location;
piloting the UAV to a second position from the first position based on determining that at least a portion of the guide rods is approximately abutting at or substantially near the desired measurement location for the power line device, wherein the at least the portion of the guide rods is close to a distal end of the guide rods and is below the power line measurement device;
reducing the altitude of the UAV to lower a measurement area of the power line measurement device onto the energized electrical power line and/or the splice such that the power line measurement device is latched onto the energized electrical power line and/or the splice; and
obtaining, by an electronic device, measurement data from the power line measurement device.
